(19) United States
(12) Patent Application Publication
(10) Pub. No.: US 2007/0164997 A1
(43) Pub. Date: Jul. 19, 2007

(54) Device for vitality diagnostics

(76) Inventor: Richard Gruber, Bad Worishofen (DE)

Correspondence Address: BACHMAN & LAPOINTE, P.C., 900 CHAPEL STREET, SUITE 1201, NEW HAVEN, CT, 06510, US

(21) Appl. No.: 10/576,537

(22) PCT Filed: Oct. 19, 2004
(86) PCT No.: PCT/EP04/11820

§ 371 Date: Jun. 18, 2006

(30) Foreign Application Priority Data
Oct. 21, 2003 (DE) 203 16 285.4

(51) Int. Cl. G09G 5/08

(52) U.S. Cl. 345/163

(57) ABSTRACT

A device for vitality diagnostics on a test person having an output unit (10) associated with a data processing device which is constructed to output a visual and/or acoustic signal for the test person, as well as an actuating and sensor device (10, 22, 42) which is set up to capture an input actuation of the test person in response to the visual or acoustic signal, wherein an output signal of the actuating and sensor device is captured as data by the data processing device and processed further for determining vitality-related data and the actuating and sensor device together with the output unit possess a common touch-sensitive and/or pressure-sensitive screen (10), wherein the screen is mounted in a screen housing (12) foldably with respect to a housing unit (16) containing the data processing device in such a way that in an operating state the screen housing sits up on the housing unit preferably lockably at least one predetermined angle and in a non-operating state the screen housing lies by its flat screen side on a flat face (20) of the housing unit.

### BACKGROUND OF THE INVENTION

The present invention relates to a device for vitality diagnostics as disclosed in German Utility Model 200 15 449.

Such a device allows the measurement of what is referred to as the biological or functional age of a test person by carrying out a plurality of individual tests in that age-dependent organ functions together with other age-related or physical parameters are measured, classified by age, gender, etc and prepared for practical use by allocation to reference groups with regard to a relative level of fitness related to the reference groups.

In doing this it has turned out that precisely the large number of tests made possible by the device according to the state of the art allows a holistic appraisal of the physical fitness of the test person so that in particular even demanding scientific requirements can be met in measurement and evaluation and so a tool is produced which with regard to demographic developments can perform valuable services in promoting health awareness as well as in preventing age-related problems.

At the same time the device disclosed by the state of the art in DE 200 15 449 makes use of a touch-sensitive screen for displaying and capturing input reactions of the test person, by means of which simplicity of operation and presentation with high reliability and operational dependability as well as ease of production can be combined. In addition, other more specialised diagnostic functions are achieved by means of individually constructed, preferably wireless-controlled sensor units (which are then manipulated manually in the required manner by the test person).

However, such a device disclosed in the state of the art is not without problems with regard in particular to ease of transport and set-up (especially with regard to mobile uses and installation and start-up by laypersons without technical background). On the one hand, the bulky workstation housing necessitated by the touch-sensitive screen requires not inconsiderable costs related to space and hence transport and, on the other hand, the plurality of manually operable sensor units additionally provided gives rise to potential confusion for untrained operators and also to additional space-related costs for transport and in use (in the case of the devices disclosed in the state of the art altogether four such manually operable sensor units are mounted vertically on the workstation housing).

Accordingly, it is an object of the present invention to simplify such a device disclosed in the state of the art and predicated as forming the generic category with regard to its mobility and portability, in particular to provide a device which at least in transport condition requires distinctly less transport volume and which additionally with regard to the manually operable sensor units gives rise to lower handling, transport and storage costs.

### SUMMARY OF THE INVENTION

This task is solved by the device specified wherein the aspects of the solution is united by the common solution idea of increased mobility and portability through foldability of the screen, folding lowerability of the actuating and sensor devices together with multiple usage of a common sensor housing by a plurality of functionalities.

Stated more precisely, it is first of all provided according to the invention for the touch- and/or pressure-sensitive screen to be designed to fold so that in an operating position the latter sits on top of the housing unit of the data processing device preferably with its angle adjustable to an angle suitable for viewing or actuation and also preferably resting securably in this position (or a plurality of positions). By flipping it over, in particular by means of a bracket provided according to a refinement, the screen housing can then be folded onto the housing unit so that a flat unit highly suitable for transport and requiring a small transport volume is produced, wherein in this configuration effective protection of the surface of the screen is additionally provided by laying it flat on a flat side of the housing unit.

Within the scope of the present invention independent protection is sought for the solution idea of providing for the at least single actuating and sensor device to be lowerable in the housing unit (alternatively, this is also a refinement of the independent solution described above). Advantageously, not only is security in transport obtained in this fashion for the delicate actuating and sensor device, but this form of implementation of the invention also makes it possible to offer the test person an operating or access position by folding it out correspondingly. Furthermore, in the collapsed state the space required for the complete configuration is minimised.

According to another independent solution, which alternatively is also to be regarded as disclosed as a refinement of the aforesaid other independent aspects of the invention, it is provided for a preferably cylindrically constructed housing accommodating at least one actuating and sensor device to be constructed with a plurality of diagnostic functionalities. In this way not only the number of actuating and sensor devices needed can be effectively reduced, but also the operating (and hence the training and explanatory) effort for the complete configuration is reduced so that as a result the ease of operating the device can be increased. In the actual implementation of this solution it has turned out to be preferable when doing so to combine the functionality directed towards the visual presentation of an optical pattern to be viewed by the test person with the functionality for capturing the power of the hand. Not only can the corresponding mechanical fittings of the bifunctional sensor unit obtained in this way be readily put into effect, but advantageously the possibility also arises of the multiple usage of the control elements provided on the housing for the actuating and sensor device (for instance, the bracket unit provided according to a refinement which, on the one hand, is provided for absorbing force and directing it into suitably assigned pressure sensors, but also, on the other hand, can be operated in the course of the further visual test functionality by the operating person for carrying out settings or for issuing confirmation signals).

Additionally, in the practical implementation of the invention it has turned out to be preferable to effect the wireless connection of the actuating and sensor devices by means radio signals. By this means not only is greater spatial flexibility achieved, by comparison with an infrared data connection for instance, but also with the aid of readily procurable radio modules implementing the radio protocols required in each case the wireless connection can be implemented with little effort and at low cost.

As a result, due to the measures taken within the framework of the present invention a significant improvement in the technology predicated as forming the generic category is produced which proves useful in particular with regard to running tests and also for transport which is frequently necessary in mobile usage. Not least, it is expected that as a result of the present solution measures the advantages of the diagnostic procedures made possible by the device according to the invention can be opened up for yet more target groups.

### BRIEF DESCRIPTION OF THE DRAWINGS

Other advantages, characteristics and details of the invention emerge from the following description of preferred exemplified embodiments as well as from the drawings. The latter show:

FIG. 1 an oblique perspective view of the device for vitality diagnostics according to the invention in a first preferred embodiment in the operational state with a screen housing held at a predetermined angle and an upright pair of actuating and sensor devices to be grasped by the operating person;

FIG. 2 a side elevation corresponding to FIG. 1 with a schematically illustrated method of folding the screen housing and a partially hidden actuating and sensor device folded down in the housing unit of the data processing device;

FIG. 3 a view of the device according to FIGS. 1 and 2 in the collapsed storage and transport state with the screen housing in the folded state with the screen lying screen-side down on an upper flat face of the housing unit and the pair of actuating and sensor devices folded down on both sides; and

FIG. 4 a lateral detail view of a bifunctional actuating and sensor device as shown in FIGS. 1 to 3.

### DETAILED DESCRIPTION

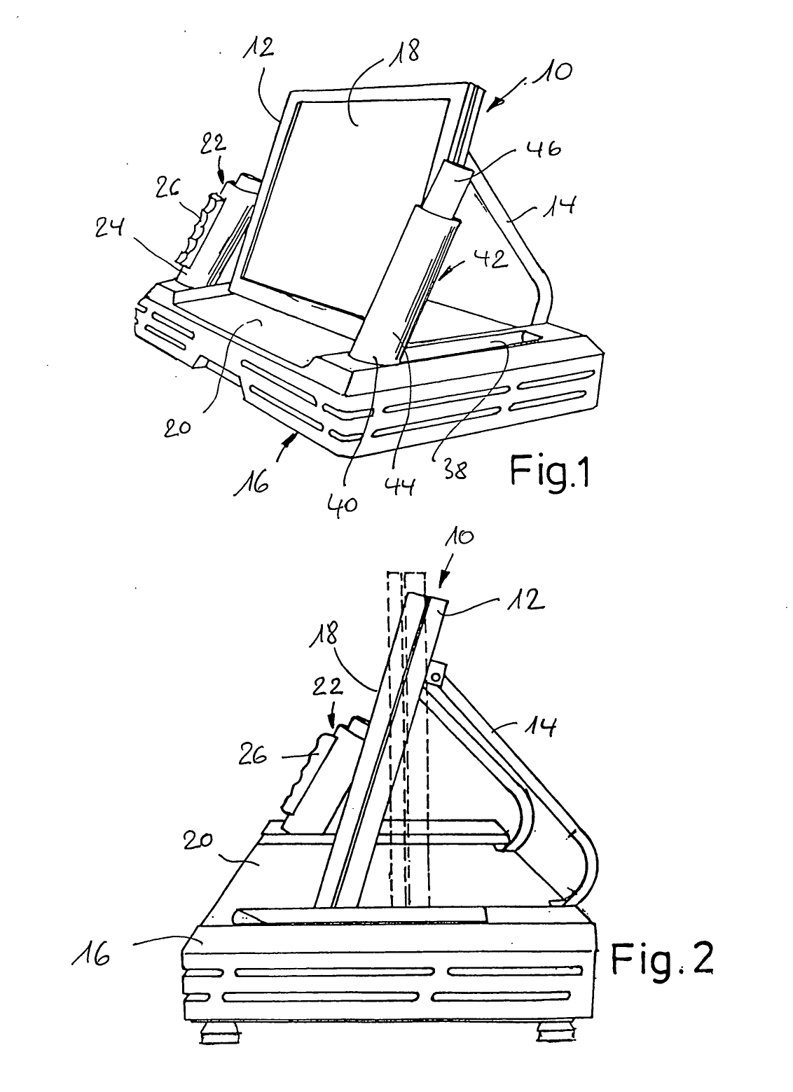

FIG. 1 shows the operational state of the device for vitality diagnostics according to the invention in a preferred embodiment. An otherwise known contact- and pressure-sensitive screen unit 10 in an associated screen housing 12 which is pivotable on a metal bracket 14 engaging on both sides Breadthwise is hinged on a flat housing (housing unit) 16 accommodating the data processing device in such a way that the screen unit 10 can be folded from the operating state shown in FIG. 1 into a storage and idle state as shown in FIG. 3, wherein for this purpose the screen unit 10 is swivelled towards the rear end of the housing 10, cf FIG. 2, and is then enclosed by the angled bracket 14, cf the plan view in FIG. 3, in such a way that the space required is minimised and the bracket 14, apart from its thickness, does not project upwardly.

As can readily be seen in FIG. 3, in this transport position the screen (presentation) side 18 of the screen unit, on which then suitable operating buttons, explanatory texts, etc are then displayed and made available for actuation, rests on a flat side of the housing 20 of the housing unit 16 so that to that extent protection is provided against harmful effects, soiling, etc.

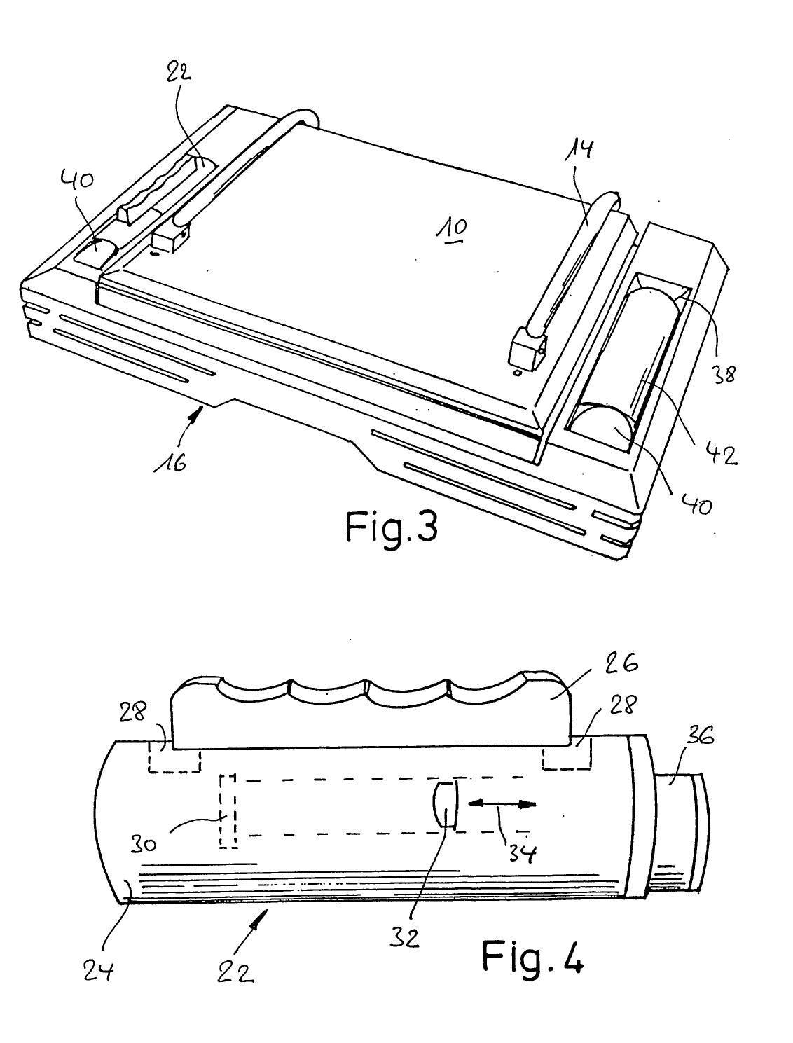

Furthermore, FIGS. 1 to 3 show the storage (accommodation) of actuating and sensor devices, which within the scope of the invention are bifunctional, on or in the housing 16. Stated more precisely, in the exemplified embodiment illustrated first of all at one end on the side of the screen unit 16 a first actuating and sensor device 22 is partially lowered and mounted collapsibly which for the planned purpose of vitality diagnosis, on the one hand, allows a measurement of the eye accommodation of test persons and, on the other hand, is constructed for measuring the power of the hand of test persons. For the latter purpose a bracket-like grip 26 is fastened on the outside of a cylindrical housing, cf FIG. 4 and the internal functional components of the first actuating and sensor device indicated by dotted lines, in such a way that by manually gripping the housing and gripping round the grip 26 which possesses suitable finger depressions a finger force can be applied to the grip and by means of a suitable mounting of the grip on the housing 24 a force is exerted on a pair of pressure sensors 28 arranged in the interior of the housing below the grip ends. The signal from the sensors is evaluated in otherwise known but not illustrated manner by means of evaluation and radio-based electronics provided in the interior of the cylindrical housing 24 and then sent in wireless manner for cleaning up and further processing to the data processing device provided in the housing 16.

In addition, for carrying out an eye accommodation measurement the first actuating and sensor device contains a light unit 30 implemented by means of luminous segments (not illustrated) arranged in a circle and illustrated only schematically by dotted lines which likewise controlled by the signalling electronics provided inside the housing generates predetermined light patterns by selective activation of the luminous segments. Associated with the light unit 30 is a lens 32 which is movable by a sliding carriage carried axially in the housing 24 which lens can be displaced by the operating person for the purpose of focussing in the direction of the arrows 34 when the operating person looks through an eyepiece 36 provided at one end of the cylindrical housing 24. Stated more precisely, he can undertake focussing in accordance with his own subjective visual situation either by actuating the grip 26 (and applying pressure to one of the two pressure sensors 28) or by actuating appropriately provided actuation fields on the screen unit 10 so that in the otherwise known fashion the eye accommodation test can be carried out by controlling the data processing device. In contrast with known displays of characters or numbers, however, using the light unit constructed for the first time here by means of the circularly arranged luminous segments (in which in test operation one or more segments are then selectively blanked out) the desired eye function is measured in thoroughly effective and diagnostically valid manner.

As can be seen by comparing FIG. 1 or 2 (in each case the first actuating or sensor unit is shown in an upright state provided for acceptance and operation by the test person) with FIG. 3 the housing 16 exhibits rounded depressions 38 on both sides of the screen unit 10 in which by means of a suitable attachment and folding piece 40 mounted at one end in the depression the actuating and sensor unit can be swivelled from a lowered storage state (to be more precise here this is only a partially lowered state) into the state of readiness shown in FIGS. 1 and 2.

This principle of storage and operation applies analogously to the second actuating and sensor unit 42 arranged to the right of the screen unit when looking at the same. In the exemplified embodiment described this too is constructed as a bifunctional device for implementing two vitality diagnostic functions, one for a lung function test and the other for a vibration test to measure the sensitivity to vibration of the hand of the test person gripping round the cylindrical housing 44 of the second actuating and sensor unit 42. More precisely, in the housing 44 a pressure sensor unit (not shown) in the form of an otherwise known Pitot tube is provided which both ahead of and behind a constriction giving rise to a standing effect measures a stream of air produced by blowing into a mouthpiece 46 of the housing 44 (by the difference in pressure ahead of and behind the constriction). From this difference in pressure with suitable analysis conclusions can then be drawn about lung volume and other parameters related to vitality of the test person handling the second actuating and sensor unit 42.

For the second functionality in the housing 44 an electromechanical vibration generator is provided immediately adjacent to the inner wall of the housing (typically implemented in the form of a solenoid with core) which suitably under control of the data processing device via a radio link and drive electronics (not shown) in the second actuating and sensor unit sets the cylindrical housing 44 in predeterminable vibrations and oscillations whereupon the test person then issues suitable recognition or confirmation signals by touching associated input surfaces on the screen unit 10.

It is also provided according to a refinement to furnish one or both actuating and sensor devices preferably peripherally with LED displays in order to indicate an orderly charging, operating and/or connection state to the main housing 16. A rechargeable secondary battery unit which is not shown is also provided in both cylindrical housings 24, 44 and by setting this up on the attachment and folding piece 40 in suitable fashion electric contact is made to it and it is supplied with charging current.

The present invention is not restricted to the embodiment illustrated. Thus, in particular, it is also conceivable to provide other functionalities in the bifunctional or multifunctional actuating and sensor devices shown, to mount a larger number of such units on or in the housing or even to provide only one such unit or none.

User guidance to or presentation of other functional tests to be implemented exclusively by means of the screen unit is carried out by analogy with the presentation in DE 200 15 449 forming the generic category and this is equally the case for other design details or details directly related to the data processing device accommodated in the housing 16 which are largely realisable with the aid of conventional PC technology.

1-14. (canceled)

15. Device for vitality diagnostics on a test person comprising an output unit (10) associated with a data processing device which is constructed to output a visual and/or acoustic signal for a test person, as well as an actuating and sensor device (10, 22, 42) which is set up to capture an input actuation of the test person in response to the visual or acoustic signal,
wherein an output signal of the actuating and sensor device is captured as data by the data processing device and processed further for determining vitality-related data
and the actuating and sensor device together with the output unit possess a common touch-sensitive and/or pressure-sensitive screen (10), wherein the screen is mounted in a screen housing (12) foldably with respect to a housing unit (16) containing the data processing device in such a way that in an operating state the screen housing sits up on the housing unit preferably lockably at least one predetermined angle and in a non-operating state the screen housing lies by its flat screen side on a flat face (20) of the housing unit.

16. Device according to claim 15, wherein the housing unit is constructed in the form of a flat housing (16) on which at an end or edge a bracket unit (14) pivotably connected to the screen housing (12) is hinged.

17. Device according to claim 16, wherein the bracket unit is constructed in such a way that in the non-operating state it lies on a rear side of the screen housing (12).

18. Device for vitality diagnostics on a test person comprising an output unit (12) associated with a data processing device which is constructed to output a visual and/or acoustic signal for the test person,
as well as an actuating and sensor device (10, 22, 42) which is set up to capture an input actuation of the test person in response to the visual or acoustic signal,
wherein an output signal of the actuating and sensor device is captured as data by the data processing device and processed further for determining vitality-related data
and the actuating and sensor device together with the output unit possess a common touch-sensitive and/or pressure-sensitive screen (10) and the data processing device is accommodated in a housing unit (16), wherein the actuating and sensor device is connected for purposes of signals and/or data to an additional manually manipulable detector and/or vibration unit (22, 42) which is constructed for actuation or manipulation by the test person as well as
for measuring the force of a hand acting on the detector unit (12)
or for measuring air pressure produced by blowing into the detector unit (42)
or for visually presenting a optical pattern viewable by the test person
or for generating a vibration signal, variably controllable preferably in frequency or amplitude, which is perceptible to the test person,
wherein the detector and/or vibration unit (22, 42) is provided to be detachable and at least partially lowerable in the housing unit (16).

19. Device according to claim 18, wherein the housing unit possesses at least one depression (38) let in to one side for accommodating the detector and/or vibration unit.

20. Device according to claim 18, wherein the detector and/or vibration unit is constructed attachably to a socket unit (40) mounted pivotably in the housing unit and/or providing a charging function for the wirelessly linked detector and/or vibration unit.

21. Device for vitality diagnostics on a test person comprising an output unit (10) associated with a data processing device which is constructed to output a visual and/or acoustic signal for the test person,
as well as an actuating and sensor device (10, 22, 42) which is set up to capture an input actuation of the test person in response to the visual or acoustic signal,
wherein an output signal of the actuating and sensor device is captured as data by the data processing device and processed further for determining vitality-related data
and the actuating and sensor device together with the output unit possess a common touch-sensitive and/or pressure-sensitive screen (10), wherein the actuating and sensor device is connected to at least one additional manually manipulable detector and/or vibration unit (22, 42) which in a housing (24, 44) connected wirelessly by signal transmission implements at least two of the following functionalities for generating the output signal:
measuring the force of a hand acting on the detector unit (22),
measuring air pressure produced by blowing into the detector unit (42),
visual presentation and, by means of an adjustable eyepiece, distortion of an optical pattern viewable by the test person,
generation of a vibration signal variably controllable in frequency or amplitude to be sensed by the test person,
wherein the screen and/or the detector and/or vibration unit is provided with means for capturing an adjustment or control movement (26) of the test person.

22. Device according to claim 21, wherein the optical pattern is constructed in the form of a figure composed of a plurality of luminous segments viewable through an eyepiece (36) which is adjustable by means of a control signal, wherein the luminous segments are constructed to be selectively addressable and are arranged preferably in the shape of a circle.

23. Device according to claim 21, wherein a bracket unit (26) is provided externally on a wirelessly linked housing (24) which unit is constructed for the application by the test person of the force of a hand to be measured to a pressure measurement unit (28) provided in the housing (24) and for the generation of operating and/or control signals by pressure actuation by the test person.

24. Device according to any one of claims 18 and 21, wherein the manually manipulable detector and/or vibration unit (22, 42) is connected to the housing unit (16) by means of a wireless link acting on the basis of microwaves or radio.

25. Device according to claim 15, wherein the data processing device for controlling the actuating and sensor device together with the output unit is constructed in such a way that the output unit produces a visually visible signal on a subdomain of the pressure-sensitive screen (10) and the actuating and sensor device is constructed for detecting a touch on the subdomain by the test person.

26. Device according to claim 25, wherein the data processing device is constructed for detecting and evaluating a sequence of touches on a plurality of subdomains in response to the display of a corresponding plurality of visually visible signals on the screen.

27. Device according to claim 15, wherein the data processing device is constructed for reproducing a preferably animated audio, text and/or image presentation for operator guidance on the screen which is activatable in response to a touch on a predetermined subdomain on the screen by the test person.

28. Device according to claim 15, wherein the data processing device possesses means for data communication with a server unit connectable via a public data transmission network.
